(19) United States
(12) Patent Application Publication
(10) Pub. No.: US 2025/0267522 A1
(43) Pub. Date: Aug. 21, 2025

(54) INDICATION OF RESOURCE ALLOCATION TO A LOW-LATENCY STATION BY PREEMPTION OF ONGOING TRANSMISSION

(71) Applicant: Samsung Electronics Co., Ltd., Suwon-si (KR)

(72) Inventors: Bilal Sadiq, Plano, TX (US); Yue Qi, Plano, TX (US); Vishnu Vardhan Ratnam, Plano, TX (US); Peshal Nayak, Plano, TX (US); Rubayet Shafin, Plano, TX (US); Boon Loong Ng, Plano, TX (US)

(21) Appl. No.: 19/056,632

(22) Filed: Feb. 18, 2025

Related U.S. Application Data
(60) Provisional application No. 63/556,297, filed on Feb. 21, 2024.

(51) Int. Cl. H04W 28/26; H04W 28/12; H04W 28/20

(52) U.S. Cl. CPC H04W 28/26; H04W 28/12; H04W 28/20

(57) ABSTRACT

The first station receives a resource indication for a resource allocation information for low latency (LL) traffic from a second station. The resource indication indicates the set of resources within a duration of a physical layer (PHY) protocol data unit (PPDU). The first station monitors the set of resources for the duration of the PPDU to receive the resource allocation information from the second station through a resource of the set of resources. The first station receives a signal carrying LL traffic from the second station for the duration of the PPDU through a resource allocated by the resource allocation information, and decodes the received signal.

### CROSS-REFERENCE TO RELATED APPLICATIONS

This application claims the benefit of priority from U.S. Provisional Application No. 63/556,297 entitled “INDICATION OF RESOURCE ALLOCATION TO A LOW-LATENCY STA BY PREEMPTION OF ONGOING TRANSMISSION,” filed Feb. 21, 2024, which is incorporated herein by reference in its entirety.

### TECHNICAL FIELD

This disclosure relates generally to a wireless communication system, and more particularly to, for example, but not limited to, indication of resource allocation to a low-latency station by preemption of ongoing transmission in a wireless communication system.

### BACKGROUND

It is necessary to reduce the channel access delay for low-latency traffic required by real-time applications (RTAs).

Low latency (LL) traffic may arrive at an access point (AP) station (STA), while the AP STA transmits a physical layer (PHY) protocol data unit (PPDU). According to the conventional ways, it is impossible to transmit the LL traffic to a non-AP STA before transmission of the PPDU ends. Accordingly, if the ongoing PPDU is long, the AP STA may transmit a next PPDU including the LL traffic after the LL traffic expires.

To solve this technological problem, the AP STA may keep all PPDUs transmissions short so that the AP STA can start transmitting LL traffic as soon as an ongoing PPDU ends when the LL traffic arrives. However, this solution may be inefficient because of the high overhead of PHY/MAC headers of the short PPDUs.

The description set forth in the background section should not be assumed to be prior art merely because it is set forth in the background section. The background section may describe aspects or embodiments of the present disclosure.

### SUMMARY

The present disclosure is directed to improvements in wireless communication. In particular, the present disclosure is directed to reduction of latencies in the wireless communication.

In some embodiments, an electronic apparatus for facilitating communication in a wireless network comprises a memory and a processor operably coupled to the memory to configure a first station. The processor is configured to cause: receiving a resource indication for a resource allocation information for low latency (LL) traffic from a second station, wherein the resource indication indicates a set of resources within a duration of a physical layer (PHY) protocol data unit (PPDU); monitoring the set of resources for the duration of the PPDU to receive the resource allocation information from the second station through a resource of the set of resources; receiving a signal carrying LL traffic from the second station within the duration of the PPDU through a resource allocated by the resource allocation information; and decoding the received signal.

In some embodiments, the resource indication indicates a duration of a respective one of the set of resources.

In some embodiments, the resource indication indicates an interval between two consecutive resources of the set of resources.

In some embodiments, the resource indication further indicates a bandwidth of a respective one of the set of resources.

In some embodiments, the bandwidth of a respective one of the set of resources is narrower than a full bandwidth of the PPDU.

In some embodiments, monitoring the set of resources comprises: determining one or more allowed resource areas within a respective one resource of the set of resources, and monitoring the one or more allowed resource areas.

In some embodiments, the one or more allowed resource areas are implicitly determined without any explicit indication from the second station.

In some embodiments, the one or more allowed resource areas are explicitly determined based on an explicit indication from the second station.

In some embodiments, the resource allocation information is disallowed to be located in two or more separate areas within a respective one resource of the set of resources. In some embodiments, decoding the received signal comprises: estimating a channel based on a reference signal in a preamble of the PPDU.

In some embodiments, the signal is another PPDU, and wherein decoding the received signal comprises: estimating a channel based on a reference signal in a preamble of the another PPDU.

In some embodiments, monitoring the set of resources comprises: estimating a channel based on a reference signal received within the set of resources.

In some embodiments, the processor is further configured to cause: stopping monitoring the set of resources for a duration of time when the resource allocation information is received.

In some embodiments, the processor is further configured to cause: transmitting, to the second station, capability information for monitoring the set of resources for the resource allocation information for the LL traffic.

In some embodiments, the processor is further configured to cause: receiving, from the second station, capability information indicating whether the station can transmit the resource allocation information for the LL traffic through the set of resources.

In some embodiments, the PPDU is addressed to a third station, and the set of resources is reserved for transmitting the resource allocation information to one or more stations including the first station.

In some embodiments, a method performed by a first station for facilitating communication in a wireless network, comprises: receiving a resource indication for a resource allocation information for low latency (LL) traffic from a second station, wherein the resource indication indicates a set of resources within a duration of a physical layer (PHY) protocol data unit (PPDU); monitoring the set of resources for the duration of the PPDU to receive the resource allocation information from the second station through a resource of the set of resources; receiving a signal carrying LL traffic from the second station for the duration of the PPDU through a resource allocated by the resource allocation information; and decoding the received signal.

In some embodiments, the resource indication indicates a duration of a respective one of the set of resources.

In some embodiments, the resource indication indicates an interval between two consecutive resources of the set of resources.

In some embodiments, the resource indication further indicates a bandwidth of a respective one of the set of resources.

### BRIEF DESCRIPTION OF THE DRAWINGS

FIG. 1 shows an example of a wireless network 100 in accordance with an embodiment.

FIG. 2 shows an example of AP 101 in accordance with an embodiment.

FIG. 3 shows an example of STA 111 in accordance with an embodiment.

FIG. 4 shows a set of resources from a TXOP that can be indicated to an LL STA for sending an LL resource allocation information message to the LL STA in accordance with an embodiment.

FIG. 5 shows allowed candidate locations within an indicated resource tile in accordance with an embodiment.

FIG. 6 shows disallowed locations within an indicated resource tile in accordance with an embodiment.

FIG. 7 shows exemplary transmission of the LL resource allocation information message and the LL PPDU in accordance with an embodiment.

FIG. 8 is a flow chart showing operations of the AP STA in accordance with an embodiment.

FIG. 9 is a flow chart showing operations of the LL STA in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

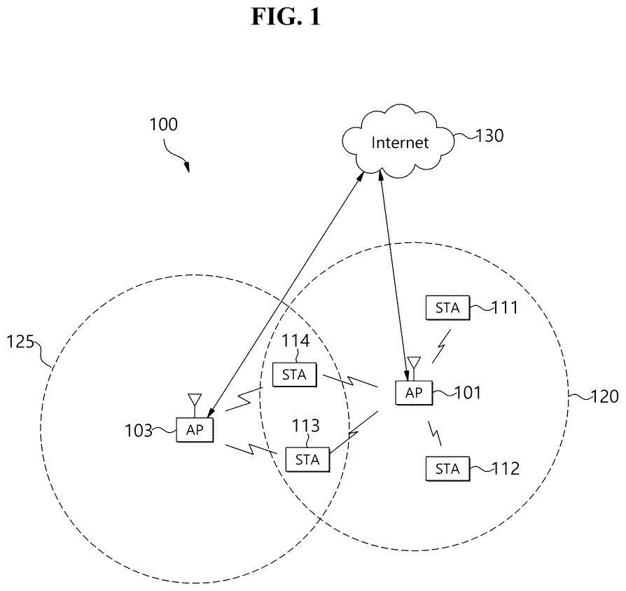

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of multi-user, multiple input, multiple output (MU-MIMO) and orthogonal frequency-division multiple access (OFDMA) channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

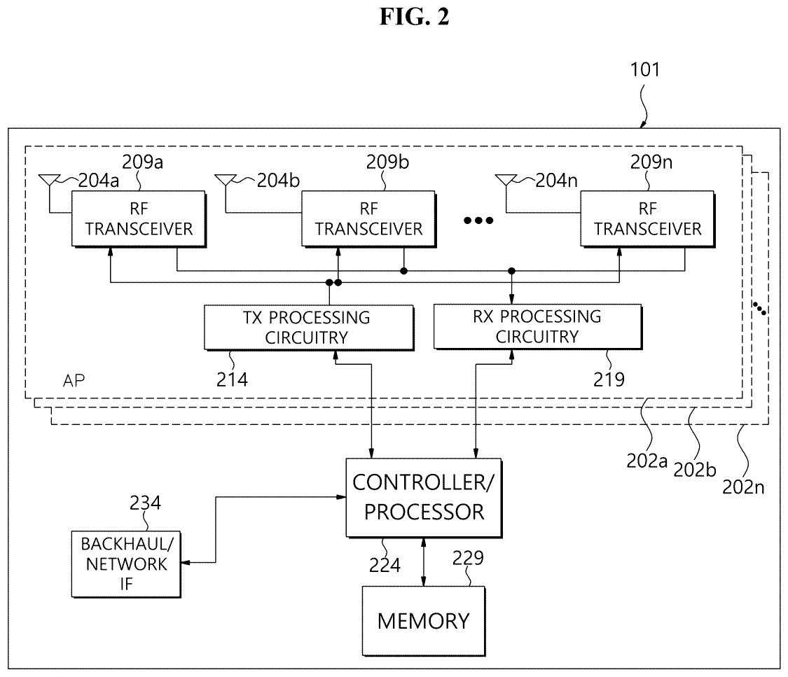

FIG. 2 shows an example of AP 101 in accordance with an embodiment. The embodiment of the AP 101 shown in FIG. 2 is for illustrative purposes, and the AP 103 of FIG. 1 could have the same or similar configuration. However, APs come in a wide range of configurations, and FIG. 2 does not limit the scope of this disclosure to any particular implementation of an AP.

As shown in FIG. 2, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2 illustrates one example of AP 101, various changes may be made to FIG. 2. For example, the AP 101 could include any number of each component shown in FIG. 2. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2 could be combined, further subdivided, or omitted and additional components could be added according to particular needs.

As shown in FIG. 2, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2 shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

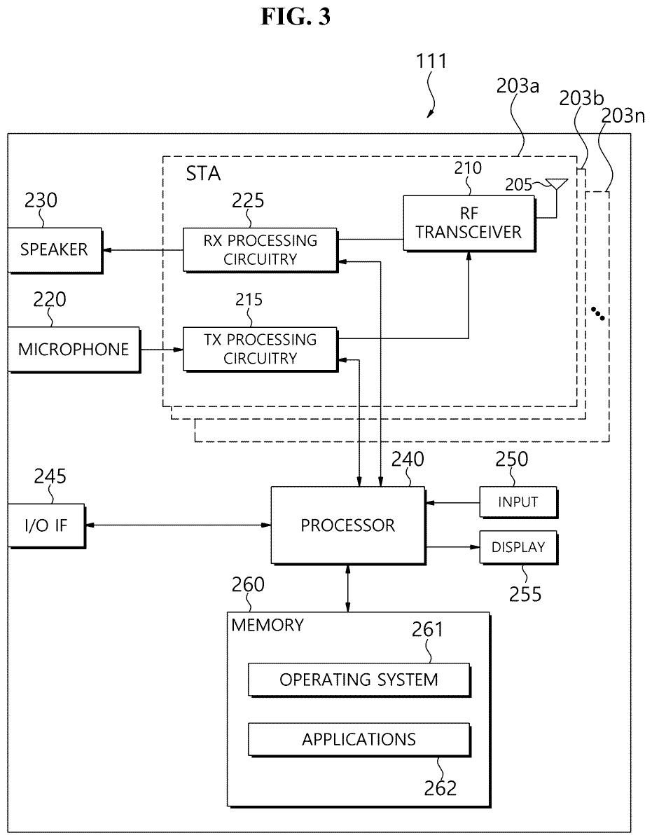

FIG. 3 shows an example of STA 111 in accordance with an embodiment. The embodiment of the STA 111 shown in FIG. 3 is for illustrative purposes, and the STAs 111-114 of FIG. 1 could have the same or similar configuration. However, STAs come in a wide variety of configurations, and FIG. 3 does not limit the scope of this disclosure to any particular implementation of a STA.

As shown in FIG. 3, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 3 shows one example of STA 111, various changes may be made to FIG. 3. For example, various components in FIG. 3 could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

As shown in FIG. 3, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 3 shows that each STA 203a-203n has a separate antenna, but each STA 203a-203n can share the antenna 205 without needing separate antennas. Each STA 203a-203n may represent a physical (PHY) layer and a lower media access control (MAC) layer.

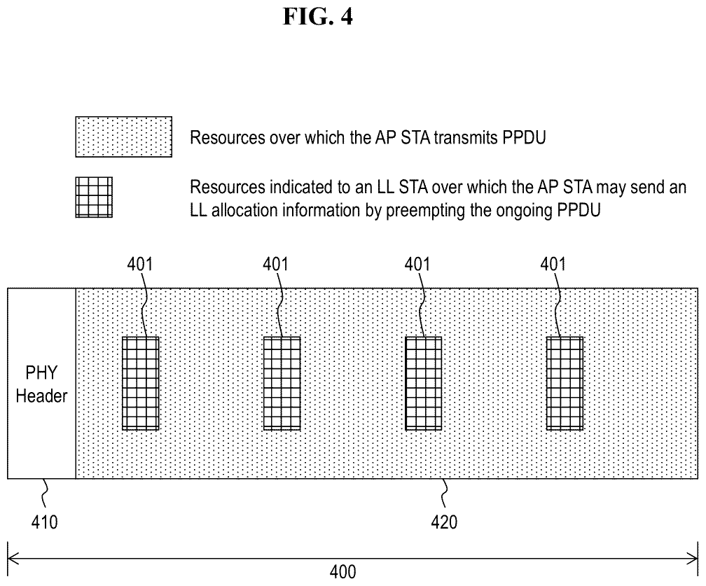

Hereinafter, transmission of LL resource allocation information messages and low-latency (LL) physical layer (PHY) protocol data unit (PPDU) to a LL STA by preemption of ongoing PPDU transmission in accordance with various embodiments will be described with reference to FIG. 4 to FIG. 9.

In this disclosure, an AP STA may transmit a message to one or more STAs, and replace or preempt at least a portion of that message with a message to an LL STA. However, the description below is also applicable if the AP STA is instead a non-AP STA device. In some embodiments, a communication device with at least part of its traffic comprising low-latency traffic may be referred to as an LL STA. This disclosure includes operations performed by the AP STA and by the LL STA, which may improve delivery of low latency traffic from the AP STA to the LL STA.

FIG. 4 shows a set of resources from a TXOP that can be indicated to an LL STA for sending an LL resource allocation information message to the LL STA in accordance with an embodiment.

Referring to FIG. 4, x-axis depicts time and y-axis depicts frequency.

FIG. 4 illustrates a non-LL downlink (DL) PPDU 400 transmitted by the AP STA. Referring to FIG. 4, the non-LL DL PPDU 400 may include a PHY header 410 and a data field 420 following the PHY header 410 and the data field 420 may include non-LL traffic.

In some embodiments, the AP STA may preempt ongoing transmission of a non-LL PPDU 400 to send an LL resource allocation information message through one resource of an indicated set of resources 401 during transmission of a data field of the non-LL PPDU 400. For example, when LL traffic arrives at the AP STA during transmission of the non-LL PPDU 400 including non-LL traffic, the AP STA may puncture one or more resources of an indicated set of resources 401 and send the LL resource allocation information message through the punctured resource during transmission of a data field of the non-LL PPDU 400. In some embodiments, the non-LL PPDU 400 may be addressed to one or more stations. In some embodiments, the one or more stations which the non-LL PPDU 400 is addressed to may be the same as, different from, or partially overlapped with one or more stations which the LL resource allocation information message is addressed to.

The LL resource allocation information message may allocate a resource for transmitting an LL PPDU 400 carrying the LL traffic to the LL STA. The LL resource allocation information message may be transmitted on one resource of resources as shown in FIG. 4. When no LL traffic arrives at the AP STA during transmission of the non-LL PPDU 400 including non-LL traffic, the AP STA may use the set of resources 401 to send non-LL traffic.

The AP STA may acquire a transmission opportunity (TXOP) for transmission. An interval of time during which a particular quality-of-service (QOS) station (STA) has the right to initiate frame exchange sequences onto the wireless medium (WM) or the resources comprising one or more channels for a duration of time for a transmission may be referred to as the TXOP. The AP STA may indicate a set of resources from the TXOP to one or more LL STAs. In some embodiments, the set of resources may be used by the AP STA to send an LL resource allocation information message for the one or more LL STAs.

In some embodiments, if there are more than one LL STAs, the AP STA may indicate the same set of resources to each of the more than one LL STAs. In some embodiments, if there are more than one LL STA, the AP STA may indicate a partially overlapping set of resources to each of the more than one LL STAs. In some embodiments, if there are more than one LL STA, the AP STA may indicate a disjoint set of resources to each of the more than one LL STAs. For example, a set of resources for the LL resource allocation information message for an LL STA may be different from a set of resources for the LL resource allocation information message for another LL STA.

In some embodiments, the set of resources may comprise at least one of resource units (RUS) in frequency domain and time windows in time domain. For example, the frequency domain resources may be indicated as a set of subcarriers, or a full width of one or more channels. In some embodiments, the set of time windows may be indicated as a subset of orthogonal frequency division multiplexing (OFDM) symbols of the AP STA's transmissions, a full duration of AP STA's PPDU, or a duration of AP STA's transmission excluding a portion of the tail end of the transmission.

As described above, the set of resources may be limited to a subset of time windows. For example, the set of resources may be limited to every n^{th} OFDM symbol, or to a subset of RUs. This may reduce the burden on an LL STA that may be required to monitor the identified resources. The burden may be in terms of power consumption and processing power.

In some embodiments, the gap between the time windows may be determined based on the latency requirements of the LL STA. For example, the time gap may be 8 OFDM symbols for a more demanding LL STA whereas it may be 32 OFDM symbols for a less demanding LL STA. In some embodiments, the time windows for the LL resource allocation information message may be periodic. In some embodiments, the time windows for the LL resource allocation information message may be aperiodic. In some embodiments, the time windows may be associated with the size of MAC protocol data units (MPDUs). For example, the time windows may be associated with a start or an end of transmission of MPDUs.

In some embodiments, the AP STA may send the indication of the set of resources in a PHY header or MAC header associated with the TXOP. The PHY header may be referred to as a preamble. For example, the AP STA may send the indication of the set of resources in the beginning portion of the TXOP. In some embodiments, the indication may be sent in part in the header and in part in an LL configuration sent to the LL STA prior to the TXOP. For example, the LL STA may obtain the indication from based on both the header of the current PPDU and LL configuration information in the previous PPDU.

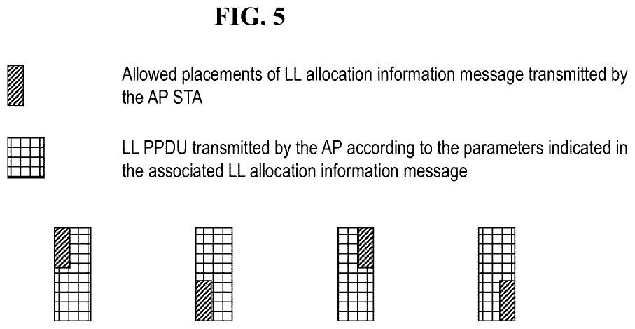

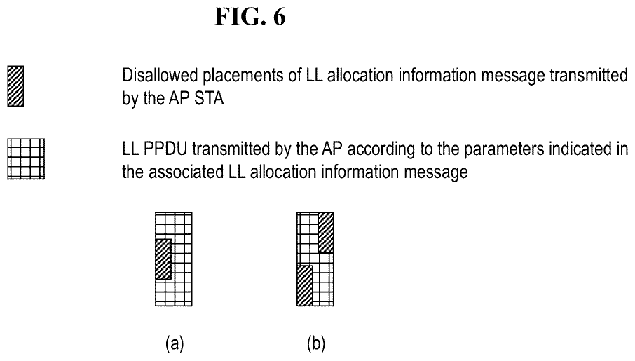

The AP STA may send the LL resource allocation information message through at least one resource of the indicated set of resources. It may be beneficial to further restrict the placement of an LL resource allocation information message within the indicated set of resources, instead of letting the AP STA arbitrarily place the allocation information message in the indicated set of resources. In some embodiments, the starting point of the allocation information message may be restricted to a subset of the set of indicated resources. For example, the starting point of the allocation information message may be restricted to specific OFDM symbols and subcarriers further sub-selected from the set of indicated resources. In some embodiments, the allowed placements or candidate locations for the placement of an LL resource allocation information message may be restricted as shown in FIG. 5 and FIG. 6.

FIG. 5 shows allowed candidate locations within an indicated resource tile in accordance with an embodiment. FIG. 5 is illustrated for one specific resource tile. In some embodiments, only four different placements for the LL resource allocation information message as shown in FIG. 5 may be allowed out of numerous possible placements. Referring to FIG. 5, the LL resource allocation information message may be allowed to be located in one of allowed candidate areas. In some embodiments, the allowed candidate areas may include all or some of a top-left corner area, a bottom-left corner area, a top-right corner area, and a bottom-right corner area within the indicated resource tile.

FIG. 6 shows disallowed locations within an indicated resource tile in accordance with an embodiment. FIG. 6 is illustrated for one specific resource tile. In some embodiments, the LL resource allocation information message may be disallowed to be located in other areas than the four different placements for the LL resource allocation information message as shown in FIG. 5, even though they are confined to the indicated resource tile. For example, as shown in part (a) of FIG. 6, the LL resource allocation information message may be disallowed to be located in a non-corner area whose one side belongs to a side of the resource tile, even if the area is within the resource tile. In some embodiments, as shown in part (b) of FIG. 6, the LL resource allocation information message may be disallowed to be located in two or more separate areas within the resource tile.

By restricting the possible placements as shown in FIG. 5 and FIG. 6, the monitoring burden on an LL STA can be significantly reduced. Yet, by allowing multiple candidate locations, the AP STA can enjoy scheduling flexibility. For example, the AP STA can pick a placement that has relatively smaller negative impact to the ongoing PPDU due to the preemption of a portion of the PPDU. Similarly, the AP STA may start to transmit an LL PPDU to a second LL STA, where the LL PPDU ends up overlapping with some of candidate areas for placements of the LL resource allocation information message for a first LL STA. So, the AP STA may flexibly choose a resource area for an LL resource allocation information message placement for the first STA that does not overlap with a resource area for the LL PPDU of the second LL STA.

In some embodiments, the allowed placements may be implicitly derived based on the indicated resources. For example, the AP STA may determine one or more allowed resource areas for the LL resource allocation information message based on the indicated resources and may transmit the LL resource allocation information message through one of the one or more allowed resource areas. The LL STA may determine one or more allowed resource areas for the LL resource allocation information message based on the indicated resources even without any indication of the one or more allowed resource areas and may receive the LL resource allocation information message through one of the one or more allowed resource areas.

In some embodiments, the allowed placements may be explicitly indicated. For example, the AP STA may determine one or more allowed resource areas for the LL resource allocation information message, may transmit an indication of the one or more allowed resource areas to the LL STA, and may transmit the LL resource allocation information message through one of the one or more allowed resource areas. The LL STA may determine one or more allowed resource areas for the LL resource allocation information message based on an indication of the one or more allowed resource areas and may receive the LL resource allocation information message through one of the one or more allowed resource areas.

In some embodiments, the indicated resource to an LL STA may be determined as the union of all allowed areas for placement of an LL resource allocation information message to the LL STA.

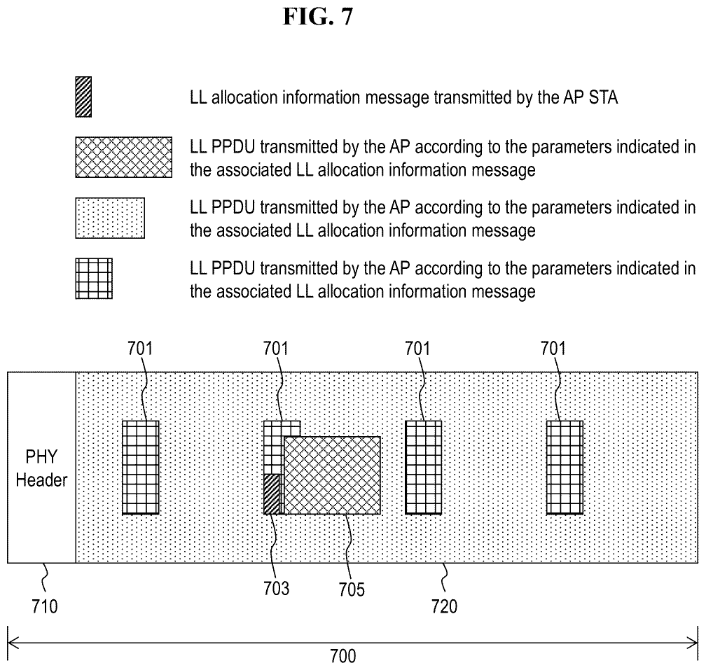

Hereinafter, transmission of the LL resource allocation information message and the LL PPDU in accordance with an embodiment will be described with reference to FIG. 7.

FIG. 7 shows exemplary transmission of the LL resource allocation information message and the LL PPDU in accordance with an embodiment.

Referring to FIG. 7, the AP STA may send an LL resource allocation information message 703 to the LL STA on the indicated set of resources 701 during transmission of a data field 720 of a current PPDU 700 carrying non-LL traffic. In some embodiments, the AP STA may place the LL resource allocation information message 703 on one of the allowed resource areas within the indicated set of resources 701.

In some embodiments, the LL resource allocation information message 703 may indicate to the LL STA one or more parameters associated with transmission of an LL PPDU from the AP STA to the LL STA. In some embodiments, the AP STA may transmit the LL PPDU 705 to the LL STA according to the one or more parameters indicated in the LL resource allocation information message 703. In some embodiments, both the LL resource allocation information message 703 and the LL PPDU 705 may preempt a portion of the ongoing PPDU 700.

In some embodiments, the AP STA may transmit the LL PPDU 705 further based on other parameters than parameters in the LL resource allocation information message. In some embodiments, the AP STA may transmit the other parameters before transmitting the LL resource allocation information message 703. In some embodiments, the PHY header 710 of the current PPDU 700, the MAC header sent in the data field 720 of the current PPDU 700, or the LL configuration information in the previous PPDU may include a message including indication of the set of resources 701 from the TXOP and the other parameters.

After sending the LL resource allocation information message 703 to the LL STA, the AP STA may be prohibited from sending the LL STA a further LL resource allocation information message for a duration of time. The duration of time may be determined based on the duration or end of transmission of the LL PPDU 705. For Example, the AP STA may be prohibited a predetermined timing margin after the transmission of the LL PPDU 705 ends. In some embodiments, the predetermined timing margin may be a processing margin in terms of SIFS or number of OFDM symbols. This prohibition on AP STA may reduce the burden on the LLATA that the LL STA may be required to keep monitoring the indicated resources while the LL STA is receiving and processing the LL PPDU 705.

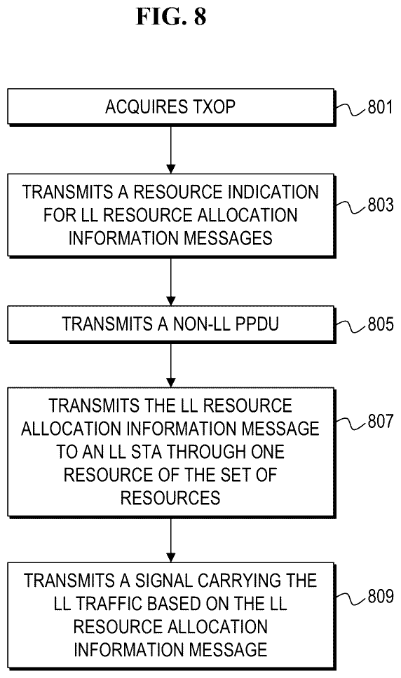

Hereinafter, the behavior of the AP STA in accordance with an embodiment will be described with reference to FIG. 8.

FIG. 8 is a flow chart showing operations of the AP STA in accordance with an embodiment.

FIG. 8 shows operations of the AP STA, but the operations shown in FIG. 8 may be performed in some embodiments.

Referring FIG. 8, at 801, the AP STA acquires TXOP and transmits an indication of the acquired TXOP.

At 803, the AP STA transmits a resource indication for LL resource allocation information messages. In some embodiments, the resource indication may indicate a set of resources for transmitting LL resource allocation information message during the acquired TXOP. In some embodiments, the set of resources may be used for one or more LL STAs to monitor an LL resource allocation information message from the AP STA. In some embodiments, a set of resource tiles within a payload of a non-LL PPDU associated with the acquired TXOP may be indicated as the set of resources.

In some embodiments, the duration of each of the resource tiles may be explicitly or implicitly indicated by the resource indication for LL resource allocation information messages. For example, the duration of each of the resource tiles may be explicitly indicated by an information field included in the resource indication for LL resource allocation information messages. In some embodiments, a predetermined value may be indicated as the duration. In some embodiments, an entire duration of the payload of the non-LL PPDU may be indicated as the duration. In some embodiments, the duration may be indicated in units of OFDM symbols. For example, the duration may be indicated as the number of the OFDM symbols. The number of the OFDM symbols may be, but not limited to, 2.

In some embodiments, the bandwidth of each of the resource tiles may be explicitly or implicitly indicated by the resource indication for LL resource allocation information messages. For example, the bandwidth of each of the resource tiles may be explicitly indicated by an information field included in the resource indication for LL resource allocation information messages. In some embodiments, a predetermined value, one or more resource units, or one or more channels may be indicated as the bandwidth. In some embodiments, a full bandwidth of the non-LL PPDU may be indicated as the bandwidth. In some embodiments, as in the 802.11 standard, a group of subcarriers in a data field following a preamble in a PPDU may be referred to as the resource unit (RU). In some embodiments, the bandwidth of the bandwidth of each of the resource tiles may be equal to or narrower than the bandwidth of the PPDU.

In some embodiments, the interval between two consecutive resource tiles may be explicitly or implicitly indicated by the resource indication for LL resource allocation information messages. For example, the interval may be explicitly indicated by an information field included in the resource indication for LL resource allocation information messages. In some embodiments, a predetermined value may be indicated as the interval. In some embodiments, the interval may be indicated in units of OFDM symbols. For example, the interval may be indicated as the number of the OFDM symbols. In some embodiments, the resource tiles may be periodic or aperiodic.

At 805, the AP STA generates and transmits a non-LL PPDU including a preamble and a payload.

The preamble may be referred to as the PHY header. In some embodiments, The preamble may include a Non-HT short training field (L-STF), a Non-HT long training field (L-LTF), a Non-HT signal (L-SIG) field, a repeated Non-HT signal (RL-SIG) field, a universal signal (U-SIG) field, an enhanced long range (ELR) short training field (ELR-STF) and an ELR long training field (ELR-LTF), and an ELR signal (ELR-SIG) field. The L-STF may be utilized for packet detection, automatic gain control (AGC), and coarse frequency-offset correction. The L-LTF may be utilized for channel estimation, fine frequency-offset correction, and symbol timing. The L-SIG field may be used to communicate rate and length information. The RL-SIG field may be a repeat of the L-SIG field and may be used to differentiate an ELR PPDU from a non-HT PPDU, an HT PPDU, a VHT PPDU, an HE PPDU, and an EHT PPDU. The U-SIG field may carry information necessary to interpret EHT PPDUs. The ELR-SIG field may provide additional signaling to the U-SIG field for STAs to interpret an ELR PPDU. In this disclosure, the U-SIG field, the ELR-SIG field, or both may be referred to as the SIG field. The ELR-STF may be used to improve automatic gain control estimation in a MIMO transmission. The ELR-LTF may enable the receiver to estimate the MIMO channel between the set of constellation mapper outputs and the receive chains. In this disclosure, the L-STF, the L-LTF, the ELR-STF, and the ELR-LTF may be referred to as a training field or a reference signal. In this disclosure, the L-STF and the ELR-STF may be referred individually or collectively to as a first STF and a second STF, respectively. In this disclosure, the L-LTF and the ELR-LTF may be referred to as a first LTF and a second LTF, respectively.

The payload may be referred to as a data field. The payload may include an MAC header and non-LL traffic addressed to a non-AP station. In some embodiments, the non-AP station may be one of the one or more LL STAs which monitor resources indicated by the resource indication for LL resource allocation information messages. In some embodiments, the non-AP station may not belong to the one or more LL STAs which monitor resources indicated by the resource indication for the LL resource allocation information messages.

In some embodiments, the PHY header of the non-LL PPDU may include the resource indication for LL resource allocation information messages. In some embodiments, the MAC header of the non-LL PPDU may include the resource indication for LL resource allocation information messages. In some embodiments, a previous PPDU of the non-LL PPDU may include the resource indication for LL resource allocation information messages. The previous PPDU may be a PPDU including LL configuration information.

At 807, if the AP STA determines that it has LL traffic for an LL STA, the AP STA transmits the LL resource allocation information message to an LL STA through one resource of the set of resources for a duration of a data field of the non-LL PPDU carrying non-LL traffic. For example, the AP STA may have received the LL traffic during or just before the start of the transmission of the non-LL PPDU carrying non-LL traffic. In some embodiments, the LL resource allocation information message may include one or more parameters. For example, one or more parameters may include some or all of a resource indication of a resource for transmitting the LL traffic, an identifier of an LL STA which the LL traffic is addressed to, the number of space-time streams, beamforming information indicating whether a beamforming steering matrix is applied to transmission of the LL traffic, modulation and coding scheme (MCS) information indicating a MCS applied to the transmission of the LL traffic, dual carrier modulation (DCM) information indicating whether DCM is used for the transmission of the LL traffic, and coding information indicating whether binary convolutional code (BCC) or low-density parity check (LDPC) is used for coding the LL traffic. In some embodiments, allowed resource areas in the one resource of the set of resources may be configured and the AP STA transmits the LL resource allocation information message through one of the allowed resource areas. As described above, all or some of a top-left corner area, a bottom-left corner area, a top-right corner area, and a bottom-right corner area of a resource tile occupied by the one resource may be the allowed area. The allowed resource area may also be configured as subcarriers distributed across the one resource of the set of resources. In some embodiments, transmission of the LL resource allocation information message over resources spanning more than one allowed area may be disallowed. In some embodiments, the LL resource allocation information message may be disallowed to be located in two or more separate areas within a single resource tile occupied by the one resource.

In some embodiments, the AP STA may perform precoding of the LL resource allocation information message differently from the data field of the non-LL PPDU and send a dedicated reference signal with each LL resource allocation information message. In some embodiments, the AP STA may transmit the dedicated reference signal within a resource through which the LL resource allocation information message is transmitted. In this scenario, the LL STA may use the dedicated reference signal to demodulate and decode the LL resource allocation information message. For example, the LL STA may use only the dedicated reference signal without using the reference signals of the non-LL PPDU to demodulate and decode the LL resource allocation information message.

At 809, the AP STA transmits a signal carrying the received LL traffic based on the LL resource allocation information message. In some embodiments, the AP STA transmits an LL PPDU carrying the received LL traffic based on one or more parameters included in the LL resource allocation information message. For example, if the LL resource allocation information message includes a resource indication of a resource for transmitting the LL traffic and an identifier of an LL STA which the LL traffic is addressed to, the AP STA may transmit an LL PPDU carrying LL traffic for a LL STA indicated by the identifier through a resource indicated by the resource indication for the LL traffic. In some embodiments, the AP STA may transmit an LL PPDU carrying the received LL traffic based on one or more parameters included in the LL resource allocation information message and further based on one or more additional parameters in a previous message of the LL resource allocation information message. The previous message may be included in the PHY header of the non-LL PPDU, the MAC header of the non-LL PPDU, or a previous PPDU including LL configuration information. In some embodiments, the one or more additional parameters may include at least one of parameters listed above as the one or more parameters of the LL resource allocation information message.

In some embodiments, the AP STA may perform precoding of the LL data (e.g., the LL PPDU) differently from the data field of the non-LL PPDU and send a dedicated reference signal with the LL data transmission. In some embodiments, the AP STA may transmit the dedicated reference signal within the resource indicated by the LL resource allocation information message. In this scenario, the LL STA may use the dedicated reference signal to demodulate and decode the LL data. For example, the LL STA may use only the dedicated reference signal without using the reference signals of the non-LL PPDU to demodulate and decode the LL data.

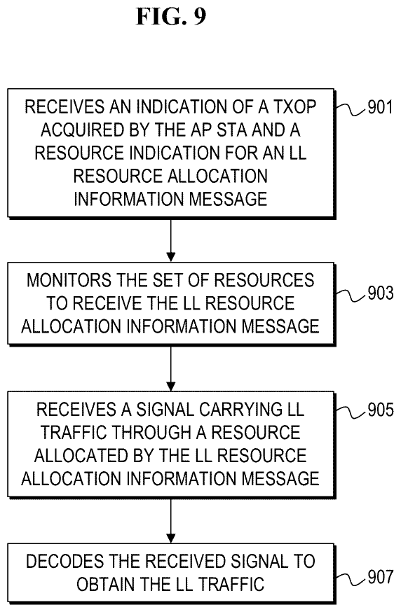

Hereinafter, the behavior of the LL STA in accordance with an embodiment will be described with reference to FIG. 9.

FIG. 9 is a flow chart showing operations of the LL STA in accordance with an embodiment.

FIG. 9 shows operations of an LL STA associated with an AP STA. In some embodiments, the LL STA may be a non-AP STA. In some embodiments, the AP STA may be replaced with a non-AP STA in the embodiments shown in FIG. 9.

Referring FIG. 9, at 901, the LL STA, from an AP STA, receives an indication of a TXOP acquired by the AP STA and a resource indication for an LL resource allocation information message for LL traffic. In some embodiments, the resource indication may indicate a set of resources for transmitting LL resource allocation information message during the acquired TXOP. In some embodiments, the set of resources may be used for the LL STA to monitor an LL resource allocation information message from the AP STA.

At 903, the LL STA monitors the set of resources to receive the LL resource allocation information message from the AP STA through one or more resources of the set of resources. In some embodiments, the LL STA may monitor the set of resources for the duration of the non-LL PPDU associated with the acquired TXOP. In some embodiments, the LL STA may determine one or more allowed resource areas within each resource of the set of resources and monitor the one or more allowed resource areas. In some embodiments, the LL STA may implicitly determine one or more allowed resource areas from the indicated set of resources without any explicit indication from the AP STA. In some embodiments, the LL STA may determine one or more allowed resource areas based on an explicit indication from the AP STA. In some embodiments, the LL STA may monitor the set of resources by performing at least one of detecting a preamble associated with the LL resource allocation information message, blind-decoding OFDM symbols, validating the reception of an LL resource allocation information message, or checking the cyclic redundancy code (CRC) or the frame check sequence (FCS). For example, the LL STA may estimate a channel based on a reference signal within the set of resources and decode the LL resource allocation information message based on the estimated channel. In some embodiments, the LL STA may receive the LL resource allocation information message through a resource of the set of resources for the duration of the PPDU. In some embodiments, the LL STA may receive the LL resource allocation information message through a resource area of the one or more allowed resource areas.

At 905, the LL STA receives a signal carrying LL traffic from the AP STA through a resource allocated by the LL resource allocation information message. In some embodiments, the LL STA may receive an LL PPDU carrying LL traffic through a resource allocated by the LL resource allocation information message for the duration of the PPDU.

At 907, the LL STA decodes the received signal to obtain the LL traffic.

In some embodiments, the LL STA may decode the received LL traffic based on an estimated channel. In some embodiments, the LL STA may estimate a channel based on at least one of the L-STF, the L-LTF, the ELR-STF, or the ELR-LTF. In some embodiments, the LL STA may estimate a channel based on a reference signal included in the LL PPDU.

In some embodiments, the LL STA may decode the received LL traffic based on the one or more parameters included in the LL resource allocation information message as described with reference to FIG. 8. In some embodiments, the LL STA may decode the received LL traffic based on the one or more additional parameters as described above with reference to FIG. 8. In some embodiments, the LL STA may decode the received LL traffic in part based on the one or more parameters included in the LL resource allocation information message and in part based on based on the one or more additional parameters.

In some embodiments, when the LL STA receives the LL resource allocation information message, the LL STA may stop monitoring the indicated set of resources for a duration of time. The duration of time may be determined based on the duration or end of LL PPDU transmission. For example, the LL STA may stop monitoring the indicated set of resources a predetermined timing margin after the transmission of the LL PPDU ends. In some embodiments, the predetermined timing margin may be a processing margin in terms of SIFS or number of OFDM symbols.

In some embodiments, the AP STA may preempt an ongoing transmission only if the transmission meets certain criteria, which may lead to improvements in wireless communication. For example, the AP STA may preempt an ongoing transmission if the transmission spans longer than a threshold, conveys more than a threshold amount of data, or contains aggregated packets from the MAC such as aggregated MPDUs. In some embodiments, the AP STA may be prohibited from preempting short transmission or transmissions of a single or non-aggregated MPDU. The LL STA may not need to monitor the set of resources for the LL resource allocation information message in transmissions that the AP STA is prohibited from preempting.

In some embodiments, the LL STA and the AP STA may exchange capability information related to low-latency operation. For example, the LL STA may inform AP STA its processing capability for monitoring the set of resources for the LL resource allocation information message. In some embodiments, the capability information may include information on the set of resources for the LL resource allocation information message. For example, the capability information may include at least one of information indicating a limit on frequency width of the indicated set of resources, information indicating a limit on a duration of time windows of the set of resources or minimum gap between the time windows, or information indicating a limit on the number of allowed placements that the LL STA need to blindly decode for a time window. In some embodiments, the information indicating a limit on frequency width may indicate that the set of resources is limited to one channel.

In some embodiments, instead of reserving some resources for LL traffic, the AP STA may use those resources for other traffic but preempt that other traffic transmission only when actually needed by LL traffic.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An electronic apparatus for facilitating communication in a wireless network, the electronic apparatus comprising a memory and a processor operably coupled to the memory to configure a first station, wherein the processor configured to cause:
receiving a resource indication for a resource allocation information for low latency (LL) traffic from a second station, wherein the resource indication indicates a set of resources within a duration of a physical layer (PHY) protocol data unit (PPDU);
monitoring the set of resources for the duration of the PPDU to receive the resource allocation information from the second station through a resource of the set of resources;
receiving a signal carrying LL traffic from the second station within the duration of the PPDU through a resource allocated by the resource allocation information; and
decoding the received signal.

2. The electronic apparatus of claim 1, wherein the resource indication indicates a duration of a respective one of the set of resources.

3. The electronic apparatus of claim 1, wherein the resource indication indicates an interval between two consecutive resources of the set of resources.

4. The electronic apparatus of claim 1, wherein the resource indication further indicates a bandwidth of a respective one of the set of resources.

5. The electronic apparatus of claim 4, wherein the bandwidth of a respective one of the set of resources is narrower than a full bandwidth of the PPDU.

6. The electronic apparatus of claim 1, wherein monitoring the set of resources comprises:
determining one or more allowed resource areas within a respective one resource of the set of resources, and
monitoring the one or more allowed resource areas.

7. The electronic apparatus of claim 6, wherein the one or more allowed resource areas are implicitly determined without any explicit indication from the second station.

8. The electronic apparatus of claim 6, wherein the one or more allowed resource areas are explicitly determined based on an explicit indication from the second station.

9. The electronic apparatus of claim 6, wherein the resource allocation information is disallowed to be located in two or more separate areas within a respective one resource of the set of resources.

10. The electronic apparatus of claim 1, wherein decoding the received signal comprises:
estimating a channel based on a reference signal in a preamble of the PPDU.

11. The electronic apparatus of claim 1, wherein the signal is another PPDU, and
wherein decoding the received signal comprises:
estimating a channel based on a reference signal in a preamble of the another PPDU.

12. The electronic apparatus of claim 1, wherein monitoring the set of resources comprises:
estimating a channel based on a reference signal received within the set of resources.

13. The electronic apparatus of claim 1, wherein the processor is further configured to cause:
stopping monitoring the set of resources for a duration of time when the resource allocation information is received.

14. The electronic apparatus of claim 1, wherein the processor is further configured to cause:
transmitting, to the second station, capability information for monitoring the set of resources for the resource allocation information for the LL traffic.

15. The electronic apparatus of claim 1, wherein the processor is further configured to cause:
receiving, from the second station, capability information indicating whether the station can transmit the resource allocation information for the LL traffic through the set of resources.

16. The electronic apparatus of claim 1, wherein the PPDU is addressed to a third station, and the set of resources is reserved for transmitting the resource allocation information to one or more stations including the first station.

17. A method performed by a first station for facilitating communication in a wireless network, comprising:
receiving a resource indication for a resource allocation information for low latency (LL) traffic from a second station, wherein the resource indication indicates a set of resources within a duration of a physical layer (PHY) protocol data unit (PPDU);
monitoring the set of resources for the duration of the PPDU to receive the resource allocation information from the second station through a resource of the set of resources;
receiving a signal carrying LL traffic from the second station for the duration of the PPDU through a resource allocated by the resource allocation information; and
decoding the received signal.

18. The method of claim 17, wherein the resource indication indicates a duration of a respective one of the set of resources.

19. The method of claim 17, wherein the resource indication indicates an interval between two consecutive resources of the set of resources.

20. The method of claim 17, wherein the resource indication further indicates a bandwidth of a respective one of the set of resources.
